(19) United States
(12) Patent Application Publication
(10) Pub. No.: US 2020/0384905 A1
(43) Pub. Date: Dec. 10, 2020

(54) SELF-LIFTING AUTOMATED GUIDIED VEHICLE

(71) Applicant: UNIVERSITY OF MIAMI, Miami, FL (US)

(72) Inventors: Yunus Topcan, Hollywood, FL (US); Emrah Celik, Pinecrest, FL (US)

(21) Appl. No.: 16/895,884

(22) Filed: Jun. 8, 2020

Related U.S. Application Data
(60) Provisional application No. 62/858,659, filed on Jun. 7, 2019.

(51) Int. Cl. B60P 1/44; G05D 1/02; B66F 9/06

(52) U.S. Cl. CPC B60P 1/445; G05D 2201/0216; B66F 9/063; G05D 1/0246

(57) ABSTRACT

Automated guided vehicles are provided having self-lifting mechanisms providing a compact and effective way to lift a heavy payload. The self-lifting AGVs are configured to mount and carry payloads that are not directly above the AGV, but rather may be in any location in a warehouse or facility. The self-lifting AGVs are able to automatically position themselves in front of a payload, automatically lift the payload, and place the payload on the AGV which is then able to move throughout a facility.

### CROSS-REFERENCE TO RELATED APPLICATIONS

This application claims priority to provisional U.S. Application Ser. No. 62/858,659, filed on Jun. 7, 2019, entitled, Self-Lifting Automated Guided Vehicle, the entire disclosure of which is hereby expressly incorporated by reference herein.

### FIELD OF THE INVENTION

The present disclosure relates to automated guided vehicles and, more particularly, to automated guided vehicles with self-lifting mechanisms for loading a payload.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Automated guided vehicles (AGVs) are vehicles that can autonomously operate in an environment to accomplish certain tasks. AGVs are most commonly used in warehouse or factory environments where payloads, mostly on pallets, must be moved to and from different locations. Warehousing companies use hundreds to thousands of small AGVs to retrieve shelves and products depending on the orders they receive.

Most conventional AGVs transporting payload by two different methods. One method is to have the payload put manually and directly onto to the AGV's back. The other method is to have an AGV drive under a suspended payload and lifting the payload from underneath. In both methodologies, the payload must be positioned right above the AGV, and extra infrastructure is needed to mount the payload onto the AGV, such as using conveyor belts to place packages on the AGV. There are numerous different AGVs in the market today, and each is limited in how payloads are mounted to the AGV. Even Autonomous forklifts, which are form of AGV, are limited in design, in particular by their obviously large.

FIG. 1A illustrates an example conventional AGV system, the OTTO 1500 available from Otto Motors of Ontario, Canada. FIG. 1B depicts another example conventional AGV system, the Comau Agile available from Comau S.p.A of Grugliasco, Italy. Both AGVs are able to move payloads. They have similar speeds, weights, and dimensions as described in Table 1. They offer high payload carrying capability and relatively fast speed. Further, multiple carriages/modules can be integrated onto these vehicles to perform a variety of tasks, such as towing or lifting. These vehicles are mostly used in warehouse and factory environments to transport payloads from point to point.

TABLE 1
Specifications of two commercially available AGVs, and pictures of them

| | OTTO 1500 | | Comau Agile | |
|---|---|---|---|---|
| Dimensions | 1810 × 1190 × 400 mm | | 1404 × 680 × 330 mm | |
| Maximum Speed | 2.0 | m/s | 1.7 | m/s |
| Maximum Payload | 1500 | kg | 1500 | kg |
| Weight | 525 | kg | 350 | kg |

These conventional AGVs are limited. Their lifting capabilities are strictly for payloads directly above the vehicles. In other words, these AGVs cannot lift payloads off the ground. The pallet that is seen on top of the OTTO 1500, for example, must be placed on the AGV by another machine. That is, additional infrastructure, such as conveyor belts, needs to be installed to allow the placements of these payloads on the vehicles, requiring additional investment to implement this type of AVG.

There is a need for improved AGVs that can address the limitations of conventional systems.

### SUMMARY OF THE INVENTION

In accordance with an example, an automated guided vehicle comprising: one or more processors; one or more memories storing processor-readable instructions; a motorized housing controllable by the one or more processors to autonomously move the automated guided vehicle from a first location to a second location proximate to a payload in a facility, the motorized housing having a mounting shoulder platform; deployable slats mounted in the motorized housing and configured for translational deployment from a stored position retracted into the motorized housing to an extended position distal from the motorized housing for engaging the payload, wherein the deployable slats comprise a telescoping raiser mechanism configured to engage the payload in a first position and to raise the payload into a loading position elevated from the first position; and a motorized extender configured to translationally deploy the deployable slats from the stored position into the extended position and configured to move the motorized housing under the payload, in response to the payload being in the loading position, wherein the payload is lowerable unto the mounting shoulder platform of the motorized housing.

In some examples, the motorized housing comprises motorized feet.

In some examples, the automated guided vehicle includes an optical imaging sensor configured to align the automated guided vehicle for extending the deployable slats into receiving openings of the payload.

In some examples, the telescoping raiser mechanism comprise one or more telescoping columns. In some such examples, the one or more telescoping columns each comprise a concentric cylinder element configuration.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIGS. 1A and 1B illustrate different examples of conventional automated guided vehicles (AGVs).

FIG. 2 illustrates process and operation that may be employed by a self-lifting AGV, in accordance with an example.

FIG. 3A illustrates an example of telescoping cylinders that may be used to actuate self-lifting slats of the AGV of FIG. 2, in accordance with an example.

FIG. 3B illustrates an example of self-lifting slats of the AGV of FIG. 2 before the telescoping cylinders have been engaged to lift the pallet, in accordance with an example.

FIG. 4 illustrates a cross-sectional view of threaded telescoping cylinders of FIG. 3A in different stages of operation, in accordance with an example.

FIG. 5 illustrates example pallets types that may carry a payload, in accordance with an example.

FIG. 6 illustrates end on views and a top down view of various example pallets, in accordance with an example.

FIG. 7 illustrates example dimensions in millimetres for an AGV, in accordance with an example.

FIG. 8 illustrates example dimensions, in millimetres for a slats assembly, in accordance with an example.

FIG. 9 illustrates an example trapezoidal thread profile that may be used for a telescoping cylinder, including example pitch, pitch height, and thread angles, in accordance with an example.

FIG. 10 illustrates a schematic defining thread parameters, in accordance with an example.

FIG. 11 illustrates axes of movement that may be controlled for telescoping cylinders, in accordance with an example.

FIG. 12 illustrates a schematic of various systems of an AGV including a controller, in accordance with an example.

FIG. 13A illustrates another AGV having a basket module, in accordance with another example.

FIG. 13B illustrates another AGV having a plate module, in accordance with another example.

### DETAILED DESCRIPTION

The present techniques provide for self-lifting mechanisms that may be used in automated guided vehicles (AGVs). The result are new vehicles (including) AGVs that provide a compact and effective way to lift a heavy payload. While the self-lifting mechanisms are describes as used in AGVs, i.e., vehicles that can autonomously operate in an environment to accomplish certain tasks, the techniques herein may be integrated into any number of vehicles beyond the examples illustrated herein.

The self-lifting AGVs described herein may be used in warehouse or factory environments where payloads, mostly on pallets, must be moved to and from different locations. Conventional AGVs typically achieve transporting payloads using one of two different methods. One is by having the payload put directly onto the AGV, and the other is by the AGV drive under a suspended payload and lifting it. In both these cases, the payload must be positioned right above the vehicle, and extra infrastructure is needed such as conveyor belts which are utilized to place packages on the AGV. The self-lifting AGVs in examples herein, on the other hand, are able to mount and carry payloads that are not directly above the AGV, but rather may be in any location in a warehouse or facility. In various examples herein, the self-lifting AGVs are able to automatically position themselves in front of a payload, for example, and without extra infrastructure, automatically lift the payload, and place the payload on the AGV which is then able to move throughout a facility. In some examples, AGVs herein are able to drive up to a pallet having a payload, deploy slats or “skis” (also termed herein “sleds”) that telescope under the pallet and lift the pallet. The AGV may then deploy into position underneath the pallet, which is then lowered onto the AGV for driving the pallet payload to any location where it needs to be dropped off. The payload may then be removed by using the same method in reverse.

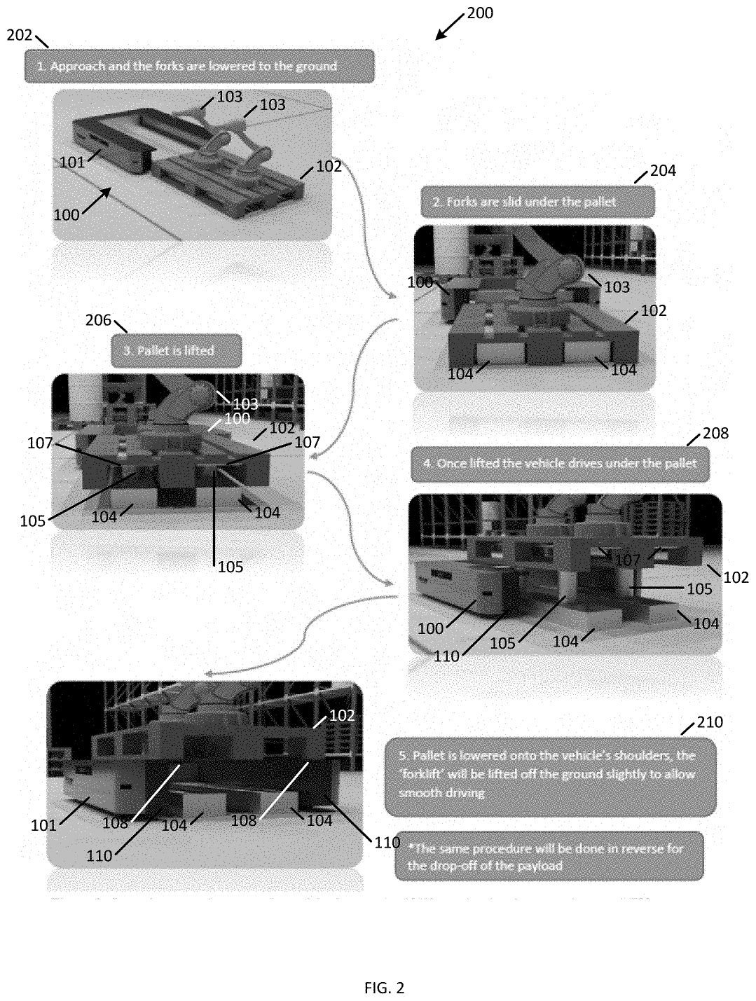

FIG. 2 illustrates a process 200 that may be employed by a self-lifting AGV 100 in accordance with an example. The self-lifting AGV 100, which has a motorized housing 101 (also termed herein a motorized body), first approaches a pallet 102 having a payload 103 mounted thereon. Movement of the AGV 100 may be motor controlled using motorized feet (e.g., extending below a lower surface of the housing 101 and engaging the floor, the feet are not shown) for movement across the floor of the facility, where these motorized feet may be remotely controlled by an operator using a computer system communicatively coupled to the AGV 100 or by an autonomous vehicle control computer system communicatively coupled to the AGV 100.

In this first step 202 of approaching the pallet 102, the AGV 100 may enter an alignment procedure, where the AGV 100 aligns itself relative to the pallet 102 for proper deploy of a lifting slats. For example, a machine vision based alignment procedure may be used, where the AGV 100 uses a mounted camera or mounted sensors to detect particular features of the pallet 102, features the AGV 100 uses to align itself for extending a self-lifting mechanism of the AGV 100 to lift the pallet 102 and subsequently place that pallet 102 onto the AGV 100.

At a second step 204, after approaching the pallet 102 and aligning itself, the AGV 100 may lower itself into a deploying position and then extends out two self-lifting slats 104, which enter into slots in the pallet 102 and extend horizontally outward from the AGV 100, i.e., from the motorized body of the AGV 100. These self-lifting slats 104 may be designed to extend along part of the enter length of a standard pallet, along a portion of the length of a standard pallet, or beyond the length of the standard pallet. The amount of horizontal deployment (e.g., the length the slats 104 extend from housing 101) of the slats 104 may depend on the computer system housed in the AGV 100 and may be made to vary based on the size of the pallet 102, which the computer system of the AGV 100 may determine through a sensor, through a pre-programed distance amount, or through other techniques.

At a third step 206, the self-lifting slats 104 lift the pallet 102, e.g., through using a set of telescoping columns 105, which may be implemented as a telescoping raiser mechanism. In the illustrated example, the AGV 100 includes two slats 104 and each slat as two telescoping columns 105. The telescoping columns 105 may be capped by a lifting plate 107, which also serves as an upper surface of the slat 104 before the telescoping columns 105 are deployed.

With the pallet 102 lifted by the slats 104 (e.g., via by the telescoping columns 105 and lifting plates 107), at a fourth step 208, the motorized housing 101 of the AGV 100 is driven underneath the pallet 102 for positioning the payload 103 under the motorized housing 101. At a fifth step 210, the pallet is lowered onto shoulders 108 of the motorized housing 101, which may itself by lifted or lifted higher off the ground to allow for smooth movement of the AGV 100 throughout the facility. As shown, in this fifth step 210, the slats 104 no longer extend horizontally from the motorized housing 101 but rather are contained within the perimeter of that housing 101. Movement of the slats 104 translationally and movement of the housing may be achieved by a motorized extender configured to translationally deploy the deployable slats from the stored position into the extended position and configured to move the motorized housing under the payload. The motorized extender may be controlled by a controller and may be configured as a motorized sprocket and gear assembly, a belt and drive assembly, a motorized ratchet and pawl assembly, a motorized assembly converting rotational movement to translational movement such as a rotating drive shaft and cam mechanism, a motorized rotating crank, or any other suitable electrically controllable drive mechanism for extending the slats and/or moving the motorized housing. In some examples, a first motorized mechanism extends the slots and a second motorized mechanism in the form of motorized feet for the housing move the housing in place under a lifted payload. In any event, the various motors herein, whether for the telescoping raise mechanism, the motorized extender, and/or the motorized feet, may be DC motors, AC motors, or others. Examples include DC shunt motors, series motors, singe or three phase induction motors, synchronous motors, stepper motors, brushless motors, universal motors, etc. Any suitable motorized assembly capable of low profile size and translational movement may be used. In some examples, a motorized extender 110 is positioned along the longitudinal length on an interior portion of the housing 101 to translate the slats 104 to the fullest extent.

The same procedure may be performed in reverse to drop off of the payload 103.

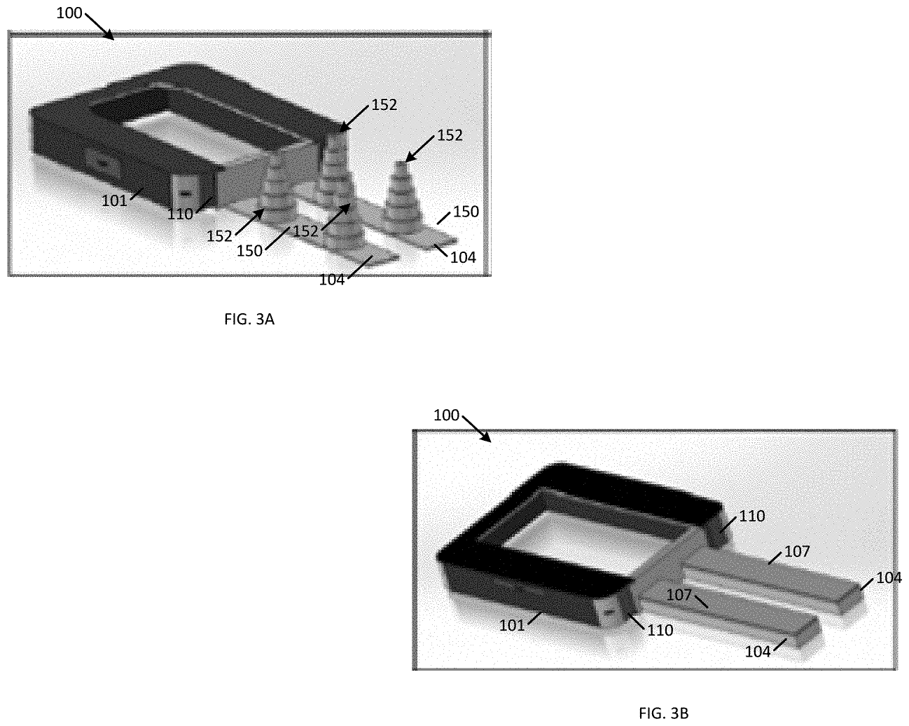

FIG. 3A illustrates an example telescoping raiser mechanism in the form of the telescoping cylinders, which may be used to actuate the self-lifting slats 104 of the pallet 102. FIG. 3B illustrates the slats before the self-lifting cylinders have been engaged to lift the pallet. The slats 104 are formed of slat bases 150 at a bottom portion of the AGV, telescoping cylinders 152 of the telescoping columns 105 electronically controlled by a computer processor and mounted on the slat bases, and the upper lifting plate 107 (which in some examples is a planar plate and in other examples may be housing surround surrounding upper portion and sides of the telescoping cylinders 152 and providing a support base for engaging a lower portion of a pallet to raise the pallet and payload.

In the illustrated example, the self-lifting slats 104 use multiple concentric threaded pipes to form the telescoping cylinders 152. By applying rotation to the outer cylinder, inner cylinders are translated upwards. FIGS. 3A & 3B show a design of the vehicle with the cylinders. The top of the most inner cylinders would be connected to the slats which would restrict any rotational motion of that cylinder.

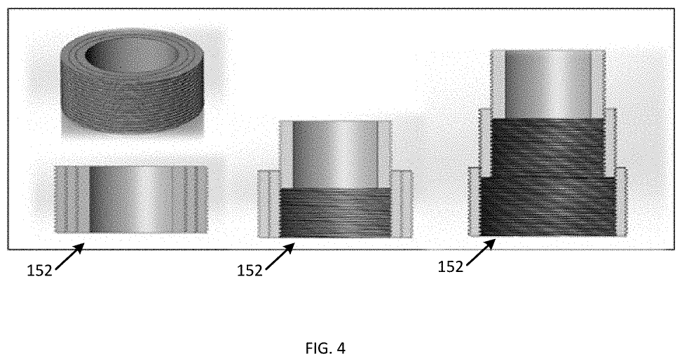

FIG. 4 illustrates a cross-sectional view of the threaded telescoping cylinders and different stages of operation. The rotation of an outer cylinder would drive the inner cylinders up when their rotation movement is fixed. The number of cylinders used may depend on the height that is needed to be lifted and the geometry of the pallet. The height may be determined by the size of the vehicle; the slimmer it is the less the payload needs to be lifted to bring it up and onto its back. The geometry of the pallet may matter too, more specifically the size of the opening. The slats should be able to fit under the pallet; therefore the height of each cylinder will be restricted by the pallet opening's height. For the AGV design in FIGS. 3A and 3B, four telescoping cylinders may be used to lift the pallet. However, the height of the telescoping cylinders could be slimmed down to reduce the number of cylinders to three, as shown in FIG. 4.

The rotation of the outer cylinder can be achieved with electric motors. Two configurations may be used, by way of example. Four motors in total: one for each group of cylinders. Or two motors in total: one for each fork. They can drive the rotation of the outer cylinder by using a belt drive or by directly connecting with a gear mechanism. In some examples, a telescoping raiser mechanism includes belt drives formed of pairs of belts and motor drives, the belts being wrapped around a base cylinder, where these belt drives may be positioned on the slat base (150) and positioned between telescoping cylinders (152).

Next we describe a design process for configuring a self-lifting AGV in accordance with an example.

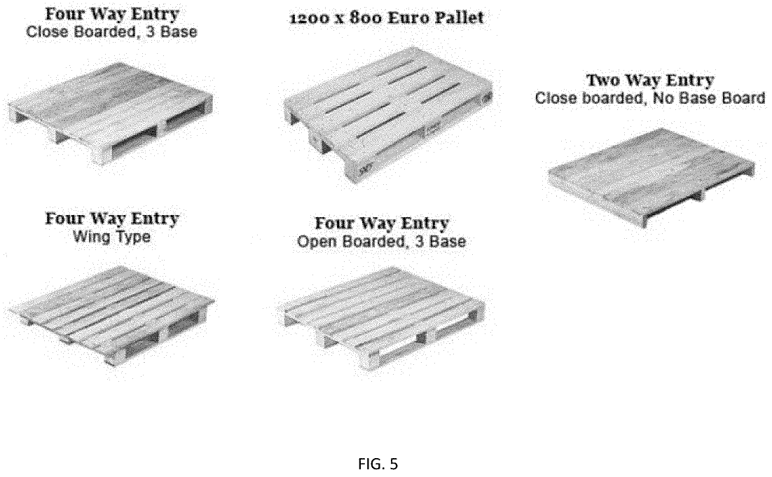

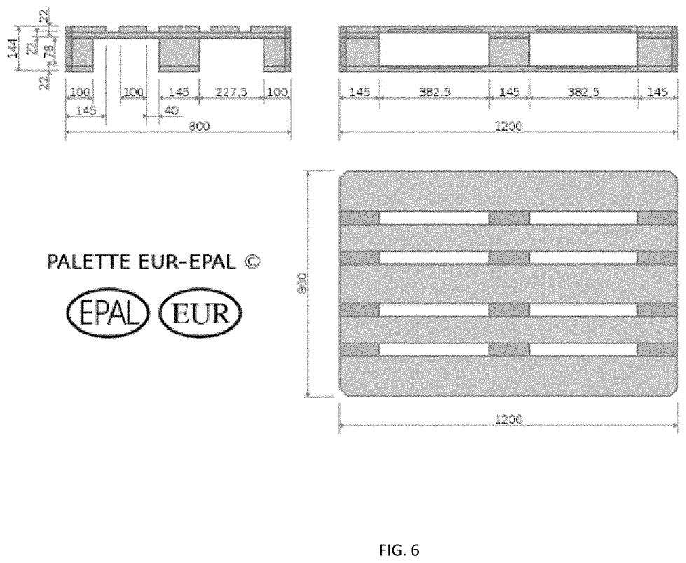

FIG. 5 illustrates example pallets types that may carry a payload. As shown, there are a wide range of pallets used in the world today for shipping and storage. The dimensions of the illustrated pallets range from 800 mm to 1300 mm in both height and width. For each, there is an opening adjacent to or near the floor, which allows the current AGV designs to take advantage because the deployable slats are in contact with or immediately adjacent to the ground when sliding underneath the pallet. The openings under these pallets are relatively large as well. The dimensions of the opening would determine the height of each telescoping cylinder and thus the number of total of concentric cylinders needed and the number of cylinders and their dimensions. Although all pallets shown in FIG. 5 are compatible with the present techniques, in an example, we used 1200×800 Euro pallet for the geometrical design because of its large dimensions. The entry opening in these pallets, as seen in the top left orientation in the FIG. 6, has a width of 227.5 mm and a height of 100 mm. These width and height dimensions are also representative of most pallets. Choosing to use this pallet as the basis of the design allowed us to determine the relative sizes of the various parts in the mechanism and vehicle.

The AGV dimensions were based on the dimensions of the pallet. Since the pallet will be sitting on the shoulders of the AGV, the AGV's height and width should be at the least equal to the pallet dimensions. The dimensions of the forks and height of the cylinders were based on the entry dimensions of the Euro pallet.

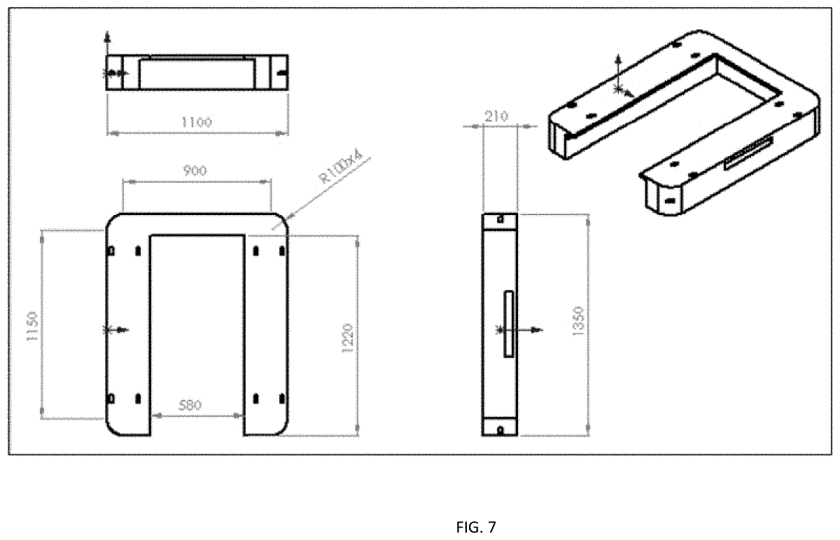

Dimensions of 1100×1350 mm were decided upon for the size of the vehicle. A U-shape was slat mechanism was used, and its corresponding dimensions are shown in FIG. 7. The height of this u-shaped slat mechanism was designed to be as small as possible to minimize the lift amount achieved by the mechanism.

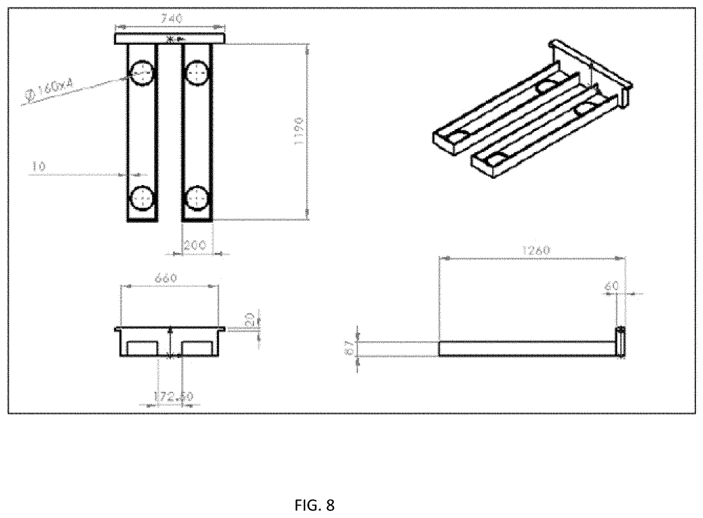

FIG. 8 illustrates example dimensions, in millimetres for a slats assembly, in accordance with an example. Slat dimensions were selected to be the height of 87 mm, and width of 200 mm. These dimensions would allow the slats to fit through the entry openings of the Euro pallet as seen in FIG. 6. The elements shown would eventually be covered with two slats (i.e., “skis”) like in FIG. 3, so the total height is slightly more than 87 mm but lower than the opening height of 100 mm.

The telescoping column, formed of the concentric telescoping cylinders, may use threads and a threaded engagement between cylinders to provide for lifting.

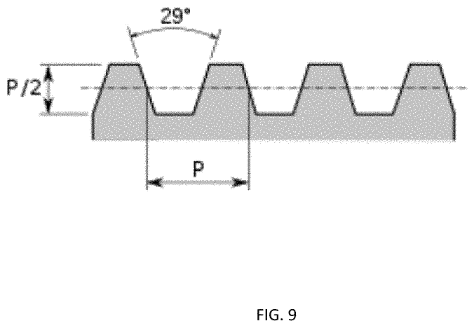

To decide on the right type of threading for the telescoping cylinders, a linkage with similar properties was investigated. Leadscrews are used in machines as linkages to translate rotation into linear motion. Screw threads, while they may be used, are considered less desirable since they are designed to have large amount of friction. Leadscrews use trapezoidal (sometimes referred to as ACME) threads, which have less friction between threads and have great load-bearing capabilities. These are also easier to machine than other profiles. This profile allows the telescoping cylinders to bear more weight than other threads. It would also ensure for the translation of rotation to linear motion to be smooth. FIG. 9 illustrates an example ACME trapezoidal thread profile that may be used for the telescoping cylinder, including example pitch, pitch height, and thread angles.

For standard threads, there are specific methods used to calculate their load capacity. In some examples, including that of FIG. 9, we use non-standard trapezoidal threads, so we cannot use any standardized method, but the same principles can be used to estimate the load capacity. The lift capacity of the proposed telescoping cylinder will depend on the strength of the threads themselves and the strength of the threaded pipe. These are calculated by using the stress and the shear areas. The stress area is the cross-sectional area of the pipe up to the threads, which is basically the area of the wall cross-section minus the threads. The shear area is the area of the threads that are in contact with each other. For the strength calculation we defined the shear area from the middle of the thread to the outer diameter.

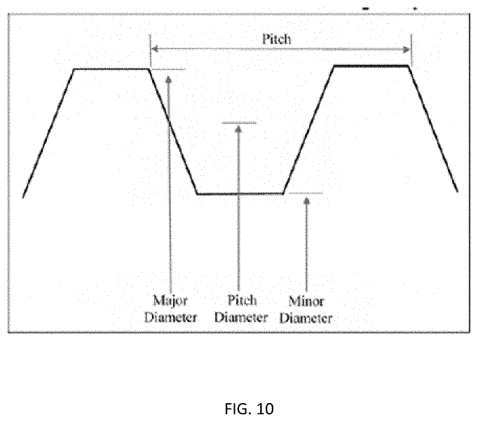

A schematic defining the thread parameters is provided in FIG. 10. Numerical values of these parameters are shown in the Table 2, and these values were used for the lift capacity calculations. Pipe dimensions were selected to be representative of the final threaded cylinders designed for the prototype.

TABLE 2
Parameters used for area calculations.

| | Pipe | | | | | | |
|---|---|---|---|---|---|---|---|
| | wall for | | | | | | |
| | stress area | | Thread dimensions | | | | |
| | (mm) | | Max | Minor | Pitch | | |
| | Outer | Inner | Diam. | Diam. | Diam. | Pitch | Thread |
| Threads | Diam. | Diam. | (mm) | (mm) | (mm) | (mm) | Angle (°) |
| Internal (outer | 114 | 109 | 103 | 109 | 106 | 6 | 29° |
| pipe) | | | | | | | |
| External | 103 | 98 | 109 | 103 | 106 | | |
| (inner pipe) | | | | | | | |

The stress and shear areas are related to strength through the material yield strength. A yield strength of 200 MPa were used in the analysis. For the shear strength calculation, the von Mises criterion were used where we can approximate the yield shear stress by multiplying the yield strength by 0.577 and a safety factor of 3 were considered in these analyses.

Stress Area

The stress area is simply the cross-sectional area of the wall at the root of the thread:

$$Stress Area Outer pipe = π ( {[ \frac{OD}{2} ]}^{2} - {[ \frac{I D}{2} ]}^{2} ) = π ( {[ \frac{114}{2} ]}^{2} - {[ \frac{109}{2} ]}^{2} ) = 875.72 {mm}^{2}$$

$$Stress Area Inner pipe = π ( {[ \frac{OD}{2} ]}^{2} - {[ \frac{I D}{2} ]}^{2} ) = π ( {[ \frac{103}{2} ]}^{2} - {[ \frac{98}{2} ]}^{2} ) = 789.33 {mm}^{2}$$

Shear Area

The shear area is calculated by stripping off one revolution of the thread and treating it as a rectangle.

$$Shear Area = π ( {D}_{max , inner} ) ( \frac{{D}_{max , inner} - {D}_{pitch}}{2} ) {( cos ( \frac{θ}{2} ) )}^{- 1} = π ( 109 ) ( \frac{109 - 106}{2} ) {( cos ( \frac{29}{2} ) )}^{- 1} = 530.55 {mm}^{2}$$

Strength

The maximum allowable force due to the stress area is:

$${F}_{max , outer} = \frac{Yield Strength \times Stress Area}{Safety Factor} = \frac{( 200 \times {10}^{6} ) \times ( 875.72 \times {10}^{- 6} )}{3} = 58 \text{,} 381 N$$

$${F}_{max , inner} = \frac{Yield Strength \times Stress Area}{Safety Factor} = \frac{( 200 \times {10}^{6} ) \times ( 789.33 \times {10}^{- 6} )}{3} = 52 \text{,} 622 N$$

The maximum allowable force due to shear for one thread is:

$${F}_{max} = \frac{0.577 \times Yield Strength \times Shear Area}{Safety Factor} = \frac{( 0.577 ) \times ( 200 \times {10}^{6} ) \times ( 530.55 \times {10}^{- 6} )}{3} = 20 \text{,} 408 N$$

The overall strength of any system is determined by its weakest link, which in this case is our threads. We can calculate the amount of mass that maximum allowable force is equivalent to:

$${M}_{max} = \frac{{F}_{max}}{Acc \text{.} of Gravity} = \frac{20 \text{,} 408}{9.81} = 2080 kg$$

According to these calculations the telescoping cylinders can hold up to 2080 kg. That is a substantially high lifting capability. If four of these mechanisms are used, the mechanism can technically lift up to approximately 8000 kg, in this example. While these values are merely examples, they demonstrate the potential of the proposed techniques for lifting heavy loads. A safety factor of 3 and a low yield strength of aluminum was used for the calculations. Different materials such as steels can have yield strengths up to 400 MPa and further increase the calculated lifting capability of our system. By contrast, the commercial AGVs currently can carry a maximum payload of 1500 kg. Thus, the present techniques could easily exceed the existing payload lifting capacity make a great contribution to this market.

The rotation motion in the telescoping cylinders may be controlled by a motor attached to the cylinders. The motor would be used to apply torque to the outer cylinder. To ensure safe and effective lifting, it is useful that the force applied by each of the four lifting mechanisms be the same during lifting (and during offloading during the reverse process). This would make sure that the pallet is lifted (and lowered) uniformly, and nothing would shift or fall off. This would also ensure that there is not one or more cylinders taking more of the load, which could cause additional wear when operating at its maximum capacity.

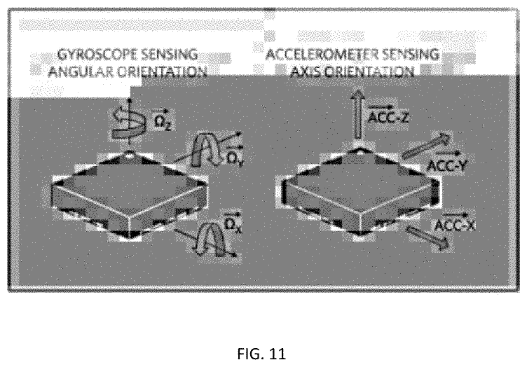

Therefore, in some examples, gyroscopes and accelerometers may be placed at each of the inner cylinders to measure any deviations. The gyroscope would measure any angular deviations and the accelerometer would measure the accelerations. All four groups of cylinders should be level at a horizontal orientation, and they should ideally be lifting at the same velocity. Force sensors can also be placed at the top of each of the inner cylinders to measure the force applied at each of the four points. FIG. 11 illustrates examples of the axes of movement that may be controlled for the telescoping cylinders.

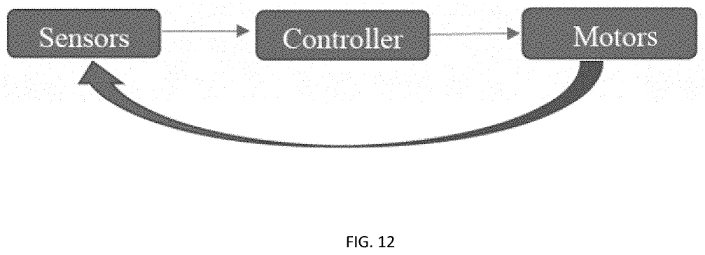

Sensors may be connected to the telescoping cylinders, and they may communicate their data to a controller as shown in FIG. 12 (such as the computer system having one or more processors and one or more memories, such as tangible computer readable media). The controller decides the amount of error present due to any deviations or misalignments. If there are deviations, the controller controls the motor to fix the error and re-align the corresponding telescoping cylinder. The controller in FIG. 12 may be mounted in the motorized housing and control all motors in the AGV, including the motorized extenders and telescoping raiser mechanisms. The controller may be configured to control certain operations based on the sensors, as shown, including by way of example optical sensors, location sensors, weight sensors, force sensors, etc.

The self-lifting AGV techniques herein are not limited to lifting payloads. The applications of use are far ranging and there may be numerous different operations occurring at the warehouse or factory. Being able to customize the vehicle's applications makes it a more versatile and marketable product.

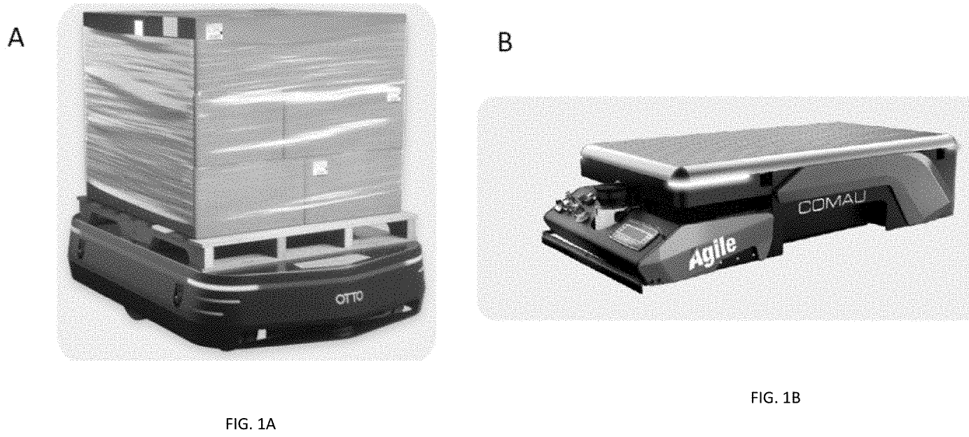

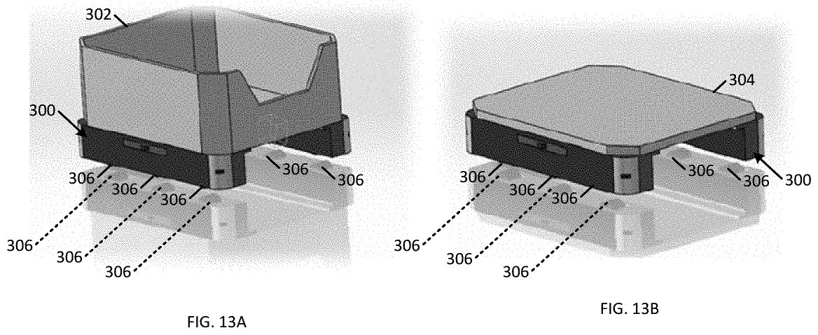

FIGS. 13A and 13B shows two different modules that can be added to an AGV 300, like the AGV 100 of FIG. 1. For a case where the user does not require lifting capabilities, these modules may be added to make it the AGV 300 an effective transporting vehicle. For example, as shown in FIG. 13A a basket 302 may be mounted to the AGV 300 to transport many smaller items such as packages, tool or materials. This would be very useful in large factories where materials need to be constantly supplied to different workstations. As shown in FIG. 13B, a plate module 304 may be mounted to give the AGV 300 providing a flat-plate surface that would allow a user to place objects or payloads onto the AGV without requiring machine lifting. For illustration purposes FIGS. 13A and 13B illustrate motorized feet 306 (some portions visible via reflection off a bottom surface for illustration purposes. These motorized feet 306 may be electrically controlled by a controller like that of FIG. 12, as is the case with the other motorized feet examples described herein.

These modules allow easy switching of applications when different needs arise.

Introducing autonomous technology into a setting is about saving time and being efficient. Someone might just require one of these vehicles, but the design would allow for them to easily switch from lifting and transporting objects to simply transporting payloads. Two different modules were discussed but other modules could be made: conveyor belts or a robot arm for complex operations. Thus, overall the applications of this vehicle are numerous and not simply limited to lifting and transporting payloads.

This detailed description is to be construed as an example only and does not describe every possible embodiment, as describing every possible embodiment would be impractical, if not impossible. One could implement numerous alternate embodiments, using either current technology or technology developed after the filing date of this application.

What is claimed:

1. An automated guided vehicle comprising:
one or more processors;
one or more memories storing processor-readable instructions;
a motorized housing controllable by the one or more processors to autonomously move the automated guided vehicle from a first location to a second location proximate to a payload in a facility, the motorized housing having a mounting shoulder platform;
deployable slats mounted in the motorized housing and configured for translational deployment from a stored position retracted into the motorized housing to an extended position distal from the motorized housing for engaging the payload, wherein the deployable slats comprise a telescoping raiser mechanism configured to engage the payload in a first position and to raise the payload into a loading position elevated from the first position; and
a motorized extender configured to translationally deploy the deployable slats from the stored position into the extended position and configured to move the motorized housing under the payload, in response to the payload being in the loading position, wherein the payload is lowerable unto the mounting shoulder platform of the motorized housing.

2. The automated guided vehicle of claim 1, wherein motorized housing comprising motorized feet.

3. The automated guided vehicle of claim 1, further comprising an optical imaging sensor configured to align the automated guided vehicle for extending the deployable slats into receiving openings of the payload.

4. The automated guided vehicle of claim 1, wherein the payload is a pallet.

5. The automated guided vehicle of claim 1, wherein the telescoping raiser mechanism comprise one or more telescoping columns.

6. The automated guided vehicle of claim 5, where the one or more telescoping columns each comprise a concentric cylinder element configuration.
